(19) United States
(12) Patent Application Publication
(10) Pub. No.: US 2012/0216673 A1
(43) Pub. Date: Aug. 30, 2012

(54) Coiled Felt Seal (CFS) Sealed Piston of Hydraulic Cylinder

(75) Inventor: Kyong Tae Chang, Academy Town (KR)

(73) Assignee: Stanley Ko, Hong Kong (HK)

(21) Appl. No.: 13/405,239

(22) Filed: Feb. 25, 2012

Related U.S. Application Data
(60) Provisional application No. 61/446,502, filed on Feb. 25, 2011.

(51) Int. Cl. F16J 15/18

(52) U.S. Cl. 92/165 R

(57) ABSTRACT

Pistons and piston rods of hydraulic cylinders are fitted with coiled felt seal (CFS) in place of rubber O-rings for the sealing of the cylinders. The resulting piston-cylinder mechanical device has a simpler structure, lesser number of components without the multiple rubber O-rings, improved durability and higher performance with extreme temperature tolerance, enhanced internal pressure capacity, reduced power loss due to reduced piston-cylinder friction, and significantly reduced leakage.

### CLAIM FOR DOMESTIC PRIORITY

This application claims priority under 35 U.S.C. §119 to the U.S. Provisional Patent Application No. 61/446,502, filed Feb. 25, 2011, the disclosure of which is incorporated herein by reference in its entirety.

### CROSS-REFERENCES TO RELATED APPLICATIONS

This application is related to the Korea Patent Application No. 10-2006-0031762, filed Apr. 7, 2006, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The presently claimed invention relates generally to piston technology and more specifically relates to the piston-cylinder sealing mechanisms.

### BACKGROUND

The piston is a component of reciprocating engines, reciprocating pumps, gas compressors, pneumatic cylinders, and other similar mechanical devices. The piston is the moving component that is contained by a cylinder and is made gas or fluid tight by piston rings.

Traditionally, the sealing of the piston and piston rod in cylinder is made by rubber O-rings. In order to achieve the effective sealing of the piston and piston rod by rubber O-rings, the rubber O-rings must maintain a certain range of elasticity. The elasticity of rubber O-ring is essential characteristic in performing the sealing function. However, at temperature below −50° C., the rubber molecules are frozen and the elasticity of rubber O-ring is lost. At temperature above +250° C., the rubber molecules carburize and the elasticity is lost as well. Therefore, the rubber O-ring sealed pistons typically are designed to operate under the ambient temperature range of between −50° C. and +250° C.

The use of rubber O-rings also limits the maximum internal pressure of hydraulic cylinder. When exposed to an internal pressure at above 450 kg/cm² the rubber is squeezed out of gap between the cylinder wall and the piston. Therefore, the rubber O-ring sealed piston-cylinders typically are designed to operate with an internal pressure of no more than 450 kg/cm².

One existing technique to overcome the temperature and pressure limitation is to use a multiple O-rings design. In such design, while the rubber O-ring is providing the sealing function, one or more assistant rings are employed on the piston and piston rod for withstanding high internal pressure of the cylinder. The sealing rubber O-ring is also being complemented by a wear ring made of hard polymer such as glass fiber reinforced phenol resin for prolonging the operational lifespan of the rubber O-ring. Other hard polymer rings maybe employed for lessening the friction between the rings and the cylinder wall. In total, there can be as many as sixteen O-rings of different functions, resulting in a complex mechanical structure, requiring costly and complicated manufacturing process.

One such multi-rubber O-ring design is illustrated in FIG. 2. As shown in the cross-sectional view of the hydraulic cylinder assembly, eleven different functioning O-rings are fitted on the piston block 25 and five different functioning O-rings are fitted on the piston rod seal block 50. The eleven different functioning O-rings on the piston block 25 include the retaining rings 34 and 44, seal rings 35, 36, and 43, back-up rings 37 and 42, slip ring 38, cushion rings 39 and 41, and wear ring 40. On the piston rod seal block 50, the five O-rings include the retaining rings 45 and 48, seal ring 46, U-packing 47, and dust wiper 49.

The use of multiple rubber O-rings for sealing also creates tremendous friction during high-speed reciprocation of the piston in the cylinder, which causes loss of power and shorter lifespan of hydraulic cylinder. To illustrate this effect, FIG. 3 shows the enlarged detail of the rubber O-rings before and after being disposed in the cylinder. The bottom drawing of FIG. 3 shows two rubber O-rings 35 and 36 secured in the O-ring groove of the piston 25. The cross-sections of both rubber O-rings 35 and 36 exhibit perfect circles when in their natural uncompressed state. The top drawing of FIG. 3 shows the two rubber O-rings 35 and 36 being compressed in similar condition of the sealing rubber O-ring being disposed in the cylinder. The flattening of the rubber O-ring generates rubber-restoring force, thus provides the sealing function between the two mating surfaces of the cylinder wall 24 and piston 25. However, the rubber-restoring force also creates friction against the cylinder wall 24.

### SUMMARY

It is an objective of the presently claimed invention to provide designs of hydraulic cylinder piston sealing using a metal dynamic sealing ring such that the aforementioned performance and manufacturing deficiencies can be eliminated. It is a further objective of the presently claimed invention to provide the design of the metal dynamic sealing ring using coiled felt seal (CFS). The CFS is a helical coiled metal seal ring.

In accordance to various embodiments of the presently claimed invention, pistons and piston rods of hydraulic cylinders are fitted with CFS. The resulting piston-cylinder mechanical device has a simpler structure, lesser number of components without the multiple rubber O-rings, improved durability and higher performance with extreme temperature tolerance, enhanced internal pressure capacity, reduced power loss due to reduced piston-cylinder friction, and significantly reduced leakage.

### BRIEF DESCRIPTION OF THE DRAWINGS

Embodiments of the invention are described in more detail hereinafter with reference to the drawings, in which:

FIG. 1 shows the cross-sectional view of one embedment of a hydraulic cylinder assembly with coiled felt seal (CFS) applied on the pistons;

FIG. 2 shows the cross-sectional view of one embedment of a hydraulic cylinder assembly with conventional multi-rubber O-rings seal applied on the pistons; and

FIG. 3 illustrates the enlarged detail of the rubber O-rings before and after being disposed in the cylinder.

### DETAILED DESCRIPTION

In the following description, designs hydraulic cylinder piston sealing using a coiled felt seal (CFS) are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

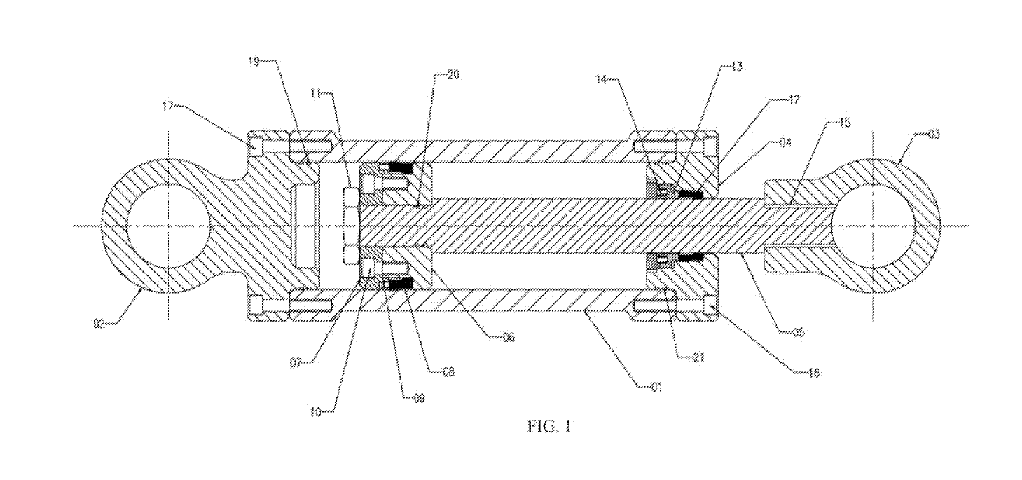

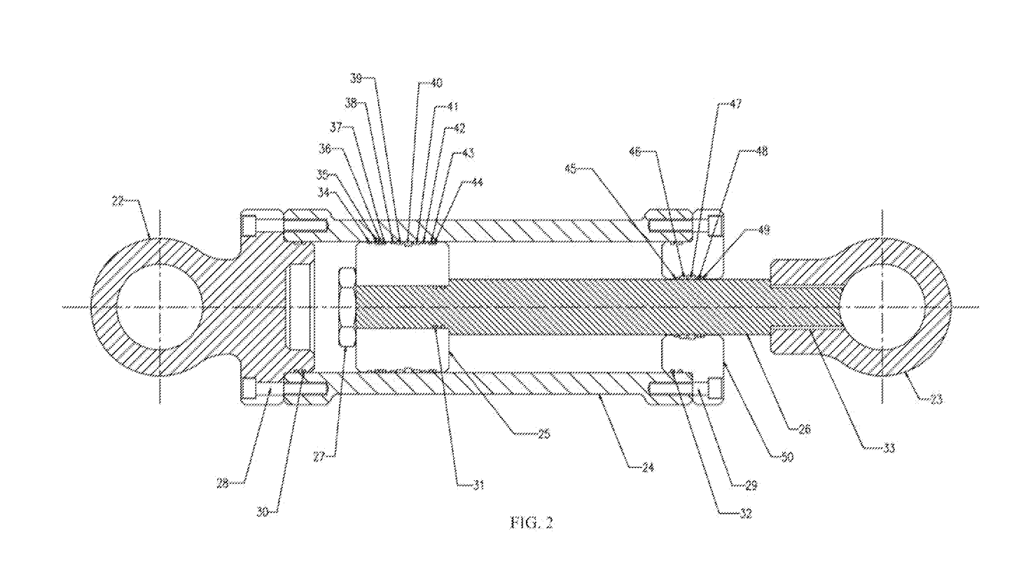

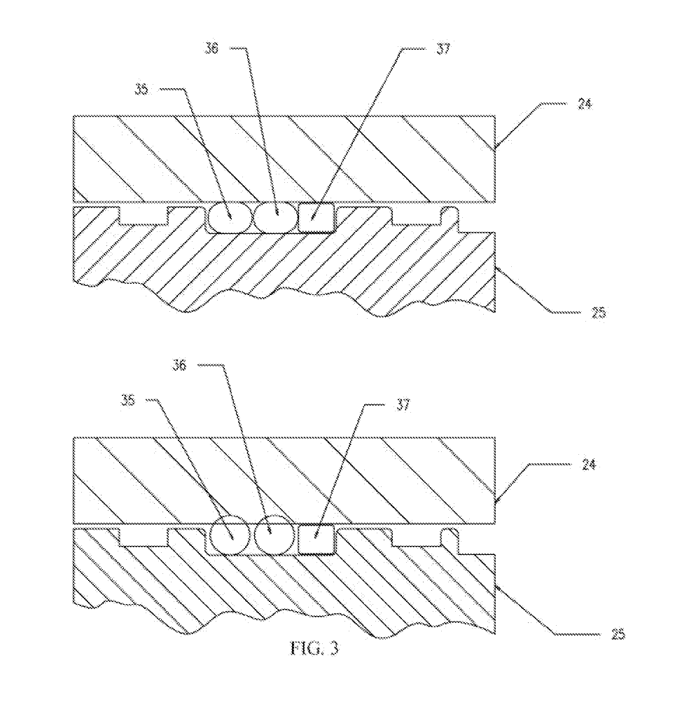

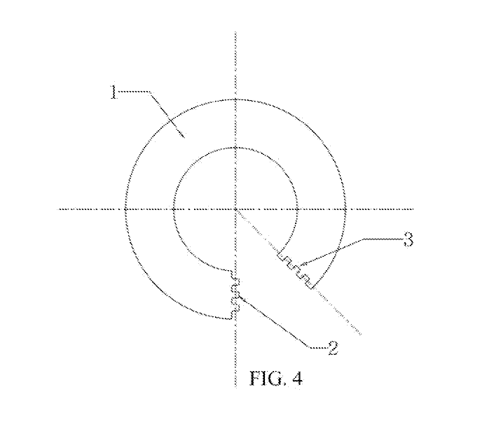

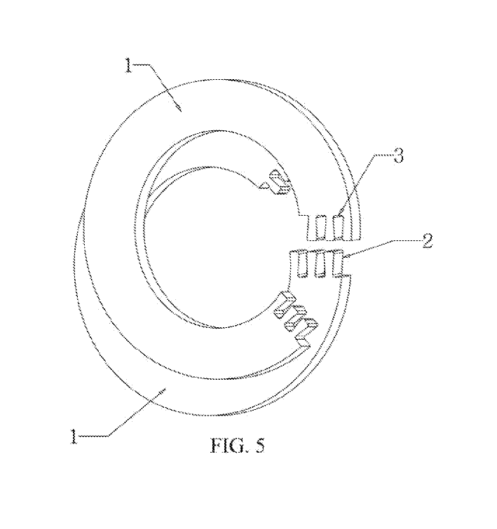

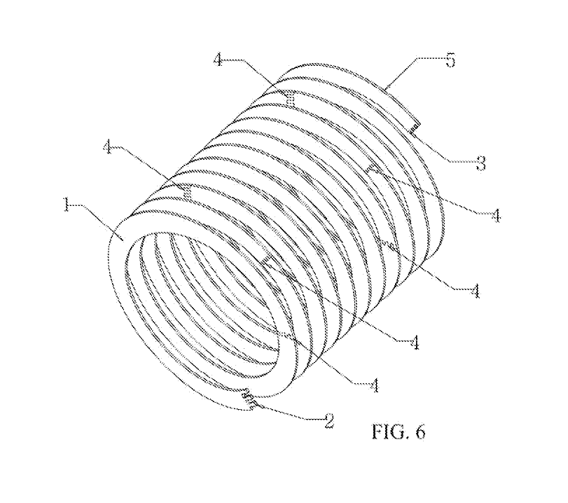

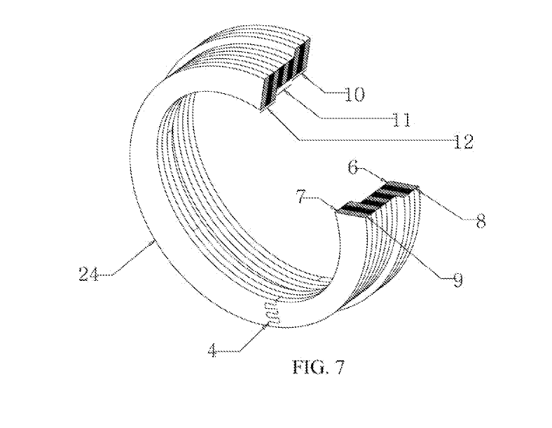

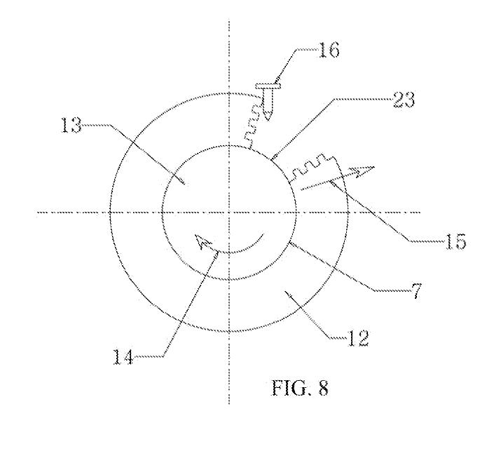

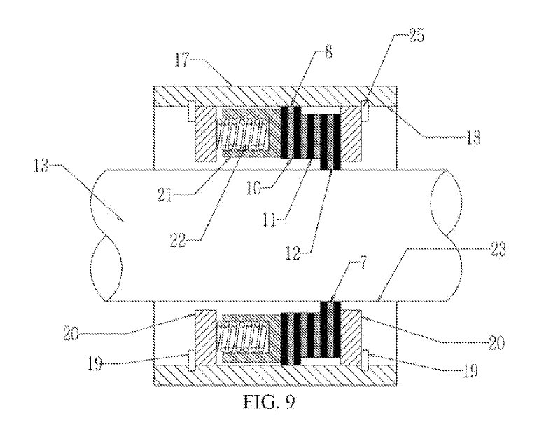

Referring to FIG. 1. The hydraulic cylinder assembly employs only one CFS 08 fitted on or tightly encircling radially the piston block 06 in place of as many as eleven different functioning rubber O-rings in the prior art. On the piston rod seal block 04 installed is a single CFS 12, instead of as many as five different functioning rubber O-rings in the prior art, for the sealing of the piston rod 05 in the cylinder. The CFS piston block seal 08 is mounted on piston block 06. The compression spring 09, that is withheld and protruded from the spring holes on the compression ring 07, provides the pressing force on the CFS piston block seal 08 to keep the source rings of the CFS intimately contacting the cylinder wall. The tight contact between the CFS and the cylinder wall reduces leakage to zero or close to zero.

The sealing between the piston block 06 and the piston rod 05 is provided by the rubber O-rings 20. Bolts 10 hold the piston block 06 and compression ring 07 together and the rod nut 11 secures the piston block 06 and the compression ring 07 at the in-cylinder end of the piston rod 05.

The link end 02 of the cylinder 01 is fastened to the cylinder by tie bolts 17. The tie end 03 of the piston rod 05 is fastened to the piston rod 05 by screw threads 15 on both the tie end 03 and the exposed end of the piston rod 05.

The piston rod seal block 04 is fastened to the interior wall of the cylinder 01 by tie bolts 16. The piston rod 05 is placed within the center opening of the piston rod seal block 04. The CFS piston rod seal 12 is installed around the inward facing side of the center opening of the piston rod seal block 04. The compression spring 14, that is withheld and protruded from the spring holes on the compression ring 13, provides the pressing force on the CFS piston rod seal 12 to keep the source rings of the CFS intimately contacting the cylinder wall. The tight contact between the CFS and the piston rod surface reduces leakage to zero or close to zero.

One embodiment of the CFS, called the helical spring tube type dynamic rotary seal, and its exemplary application are described in the Korea Patent Application No. 10-2006-0031762. Excerpts of its English translation are presented in the Appendix A of the present document.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

### APPENDIX A

Helical Spring Tube Type Dynamic Rotary Seal Constructed with C-Type Partial Rings, Which are Joined by Dovetail Joint Method

### BRIEF DESCRIPTION OF DRAWINGS

FIG. 4: Partial ring which could be press stamped out of thin metal sheet, that having male and female dovetail joint shape on two ends to make the joints be strong when progressively joined.

FIG. 5: Two partial rings are overlapped to insert male dovetail of first partial ring into female dovetail of next partial ring for progressive joining to construct helical wound tube.

FIG. 6: Blank of the tubular shape seal of this invention, which is metal strap wound helical tube.

FIG. 7: Partially cutaway view of completed dynamic seal of this invention which is completed by grinding the inside and outside diameter of the blank to have proper function in the seal.

FIG. 8: A partial ring with assisting imaginary parts to explain the dynamic rotary seal principle with this invention.

FIG. 9: Half cutaway view of example of completed dynamic rotary seal using this invention.

### EXPLANATION OF NUMBERED PARTS IN THE DRAWINGS FIGS. 4-9

1—A partial ring stamped out of thin metal sheet.

2—Male end of dovetail joint on C-type partial ring.

3—Female end of dovetail joint on C-type partial ring.

4—Dovetail Joint line, which is the result of dovetail joining of C-type partial rings.

5—Helical spring tube constructed by progressive joining of number of C-type partial rings along the helical track.

6—Shaft free circle that made slightly bigger diameter than the shaft diameter to keep it away from shaft all the time.

7—Shaft contact circle that made slightly smaller than shaft diameter to make it keep contact with shaft all the time.

8—Housing contact circle that made slightly bigger than inside diameter of the housing to make it keep contact with housing all the time.

9—Housing free circle that made slightly smaller than inside diameter of the housing to keep it away from the housing all the time.

10—Hosing seal layer whose outside diameter is housing contact circle and inside diameter is shaft free circle.

11—Displacement absorption layer whose outside diameter is housing free circle and inside diameter is shaft free circle.

12—Shaft seal layer whose outside diameter is housing free circle and inside diameter is shaft contact circle.

13—Shaft.

14—Arrow to indicate the shaft rotating direction.

15—Arrow to indicate the spreading direction of shaft seal ring when the ring spreads.

16—An imaginary pin which blocks rotating of shaft seal ring.

17—Housing.

18—Inside diameter of the housing.

19—Snap ring that inserted in snap ring groove to the hold holding ring.

20—Holding ring that holds the seal ring assembly.

21—Compression ring that pushes source rings of seal ring assembly to keep all the rings in seal ring assembly be tightly contacted one another to block leak between rings.

22—Compression spring to provide compression force of compression ring.

23—Outside diameter of the rotating shaft.

24—Completed seal assembly.

25—Snap ring groove.

### DETAILED DESCRIPTION

Category of this invention falls in the dynamic blocking technology of the leak that inevitably arising between stationary housing and rotating shaft when pressure rises in the rotary compression system.

The dynamic rotary seal used on screw type compression system is called “mechanical seal”. A mechanical seal is composed of six parts in minimum, which are the stator block, rotor block, stator disk, rotor disk, rotor disk spring and rotor block disk seal. The entire seal function fails if any one of these parts fails. The stator disk and the rotor disk are the parts that perform the actual sealing function by contacting rubbing rotating under pressure. Those two parts must have not only high wear resistance but also low friction. They must be able to dissipate heat in possible highest speed.

Surface area can be adjusted for less contacting area for less friction heat but the less area results faster wear out. High wear resistant materials have high friction but low friction material having low wear resistance. If they are made with high wear resistant material for long life the friction heat could affect the quality of the media in contact, in some cases even bring fire.

Two contacting faces in mechanical seal are under pressure and constantly rubbing so they are wearing in all instance even submicron unit range but that submicron wear clearance always causes whole seal failure when the submicron wear is not compensated in every instance along with wear out.

In other words, one of the contacting disk, rotating disk, must move toward the mating disk, the stationary disk, to compensate wear. This means the rotating disk must travel axial direction toward the stationary disk on the rotating block while the rotating block is rotating. Rotating disk must be able to slide on the rotating block to constantly move toward the stationary disk. Thus there is another place to block leak between rotating disk and rotating block.

The axial direction movement of the rotating disk on the rotating block by wear out of disk is very little distance, within few mm in a year, so the sealing between rotating disk and rotating block could be satisfied by simple rubber O-ring for cheaper model and by metal bellows for higher performance. In short the real problem in rotary dynamic seal in prior art is in the sealing between rotating disk and rotor block, not only in contacting disks.

A rubber O-ring inserted between rotating disk and rotor block shall be burnt in high temperature media and shall be extruded under high pressure media and be attacked in the corrosive media but there are no ways to omit it.

Metal bellows are more expensive, sometimes three times of the whole mechanical seal, and the metal bellows makes complicate structure which hinders thin compact design that is very important in precision machines.

The ultimate target is to produce single piece rotary dynamic seal which is compact, higher sealing performance, cheaper and lower maintenance while the rotary dynamic sealing system of prior art which generally called mechanical seal having so many parts are inevitably inter related, complicate structure, expensive in production cost, higher maintenance cost and shorter life.

FIG. 4 shows the C-shaped partial ring(1) which is the basic source ring of this invention. Partial ring(1) must be stamped out by press or fabricated by contour cutting process such as laser cutting or wire cutting from sheet stock to have two faces of partial ring(1) in perfect parallel. C-shaped partial ring(1) is a ring that made to have a part of the ring cut away so as to make the partial rings be progressively joined by the male dovetail(2) and female dovetail(3) made on two ends of the partial ring(1). The value of the cut away angle should be determined accordingly along with diameter.

FIG. 5 shows the method of progressive joining of two partial rings(1) by the male dovetail(2) of first partial ring(1) and female dovetail(3) of next partial ring(1).

FIG. 6 shows the completed helical spring tube(5) by progressive joining of partial rings(1) and those dovetail joint line(4) must be permanently set by welding or brazing after joining The starting point shows the male dovetail(2) and the ending point shows female dovetail(3) on completed helical spring tube(5). As the helical spring tube(5) is constructed by the progressive joining of the partial rings(1) the dovetail joint line(4) shall be distributed on the tube surface on shifted point as much as the cutaway angle of the partial ring(1) so the dovetail joint line(4) will be adequately distributed on tube surface evading weak joint points be overlapped.

FIG. 7 shows the partial cutaway view of seal assembly(24) which is completed sealing ring of this invention. The seal assembly(24) is completed by grinding of inner diameter and outer diameter by making 4 different diameters, two on inside and two on outside of the helical spring tube(5). The smaller diameter of the inside diameter of seal assembly (24) is called shaft contacting circle(7) which is made about 0.5% smaller than the outside diameter of the shaft(23) so as to tightly contact with shaft(13) all the time when the shaft(13) is inserted inside of the seal assembly(24). The larger diameter of the inside diameter of seal assembly(24) is called shaft free circle(6) which made little larger than the outside diameter of the shaft(23) so as to prevent shaft free circle(6) from contacting outside diameter of the shaft(23) at anytime. The larger diameter of the outside diameter of seal assembly(24) is called housing contact circle(8) which is made about 0.5% larger than the inside diameter of the housing(18) so as to keep the housing contact circle(8) tightly contact all the time with inside diameter of the housing(18) when the seal assembly(24) is assembled inside of the housing(17). The smaller diameter of the outside diameter of the seal assembly (24) is called housing free circle(9) which made little smaller than the inside diameter of the housing(18) to prevent the housing free circle(9) from contacting the inside diameter of the housing(18) at anytime. The purpose of making these 4 different diameter circle is to build three different functioned layers in the seal assembly(24). The first layer is called housing seal layer(10), which is the stacking of the housing seal rings whose outside diameter is housing contact circle(8) and inside diameter is shaft free circle(6). The function of the housing seal layer is blocking the leak between inside diameter of the housing(18) and seal assembly(24) and the number of the rings to construct layer for optimum sealing performance shall be determined by designer according to different sizes. The second layer is called shaft seal layer(12) which is the stacking of the shaft seal rings whose outside diameter is housing free circle(9) and inside diameter is shaft contact circle(7). The function of the shaft seal layer is blocking the leak between outside diameter of the shaft(23) and seal assembly(24) and the number of the rings to construct layer for optimum sealing performance shall be determined by designer according to different sizes. The third layer is called displacement absorption layer(11) which is stacking of the suspended rings whose outside diameter is housing free circle(9) and the inside diameter is shaft free circle(6). The displacement absorption layer(11) is built between the housing seal layer(10) and the shaft seal layer(12) to absorb eccentric vibration of the shaft and also absorbs the dimensional change of the whole system by wearing along with use.

FIG. 8 shows the principle of the sealing of this invention. Since those three different functioned layers are constructed on a single strand of metal strap any force put to any point of the seal assembly(24) is immediately affects to all over the seal assembly(24). When the seal assembly(24) is inserted inside of the housing(17) with force the seal assembly(24) is tightly caught inside of the housing(17) because the outmost diameter of the seal assembly(24) is the housing contact circle(8) which is 0.5% larger than the inside diameter of the housing(18). As the housing seal layer(10) is tightly caught to the housing(17) whole seal assembly(24) is caught in the housing(17) so is the shaft seal layer(12). The innermost diameter of the seal assembly(24) which is the inner diameter of the shaft seal layer(12) is shaft contact circle(7) which is made about 0.5% smaller than the outside diameter of the shaft(23) so if the shaft(13) is inserted into shaft seal layer(12) by force whole shaft seal layer(13) must be tightly stick to shaft(13). If the shaft(13) starts rotate the shaft seal layer(12) also starts to rotate together with shaft(13) but the housing seal layer(10) which is tightly caught inside of the housing(17) prevents the shaft seal layer(12) from rotating.

This condition is as same as the FIG. 8 that shows one partial ring of the shaft seal layer(12) is about to start rotate by the rotating force of the shaft(13), the stopping action of the housing seal layer(10) is shown by imaginary stop pin(16). The shaft contact circle(7) is holding shaft diameter(23) but the shaft(13) starts to rotate to arrow(14) direction while the stop pin(16) prevents the ring(12) from rotate, then the friction force between shaft contact circle(7) and shaft diameter(23) is converted to open the partial ring(12) to the arrow(15) direction. When the partial ring(12) opens by the force arrow(15) direction the contacts between the ring(12) and shaft(13) is broken, other words there remain no more contact in that instance. No more contact means no more friction force generates so opening of the ring(12) is ended and spring back to its original position. Back to its original position of the ring(12) means the contacting of the ring(12) and shaft(13) and next instance the friction force opens the ring(12) again. The opening between the ring(12) and the shaft(13) could be a millionths of a mm since the open is open no matter how small value was the opening which is enough distance to eliminate contacting. So the open and close of the ring(12) could arise million times in a second in other words the opening clearance also could be millionths of a mm through which nothing can be leak in a millionths of a second. This condition is as same as the static seal of plain rubber O-ring since the contacting of ring(12) and shaft(13) is virtually never broken during the rotating of the shaft(13). This status is a unique phenomenon arising between helical spring and rotating round bar inserted inside of the spring, the condition should be called contacting non contacting condition. This contacting non-contacting phenomenon is utilized on helical spring over running clutch from long time ago but utilizing this phenomenon on dynamic seal is the first on this invention.

FIG. 9 is the representative drawing which shows the cutout view of completed dynamic rotary seal using seal assembly(24). There must be some means to hold the seal assembly(24) inside the cylinder(17) including holding ring(20) and snap ring(19) which is inserted in the snap ring groove(25). The compression ring(21) also provided to push source rings together to block leak between source rings by the spring force of the compression springs(22) which inserted in the holes made on the compression ring(21).

What is claimed is:

1. A hydraulic cylinder assembly, comprising:
a cylinder having an interior wall; and
a piston comprising a piston block and a piston rod;
wherein the piston block being attached to the piston rod at a first end that is disposed inside the cylinder;
wherein the piston block being tightly encircled radially by one or more metal dynamic sealing rings; and
wherein the one or more metal dynamic sealing rings being in intimate contact with the interior wall of the cylinder, providing sealing function to the piston.

2. The hydraulic cylinder assembly of claim 1, wherein the metallic sealing rings being coiled felt seals (CFS).

3. The hydraulic cylinder assembly of claim 1, further comprising a piston rod seal block;
wherein the piston rod seal block being fastened to the interior wall of the cylinder with the piston rod being disposed in a center opening of the piston rod seal block;
wherein one or more metal dynamic sealing rings are installed around an inward facing side of the center opening of the piston rod seal block; and
wherein the one or more metal dynamic sealing rings being in intimate contact with the piston rod surface, providing sealing function to the piston.

4. The hydraulic cylinder assembly of claim 3, wherein the metallic sealing rings being coiled felt seals (CFS).
